(19) United States
(12) Patent Application Publication
(10) Pub. No.: US 2023/0202616 A1
(43) Pub. Date: Jun. 29, 2023

(54) CONTROL DEVICE FOR HUMAN-POWERED VEHICLE

(71) Applicant: Shimano Inc., Osaka (JP)

(72) Inventors: Satoshi SHAHANA, Osaka (JP); Tadaharu KUROTOBI, Osaka (JP)

(21) Appl. No.: 17/982,782

(22) Filed: Nov. 8, 2022

(30) Foreign Application Priority Data
Dec. 28, 2021 (JP) 2021-214230

(51) Int. Cl. B62M 6/50; B62M 9/122; B62M 6/55; B62M 9/123

(52) U.S. Cl. CPC B62M 6/50; B62M 9/122; B62M 6/55; B62M 9/123

(57) ABSTRACT

A control device includes an electronic controller that controls a motor of a human-powered vehicle. The electronic controller outputs a signal to change a transmission ratio by operating a linking body with a derailleur while driving the linking body with the motor where a first condition related to pedaling is satisfied. The first condition relates to at least one of a pedal state, a human driving force input to the pedal, a crank arm state, a human driving force input to the crank arm, a crank axle angular acceleration, a rotational state of a first rotational body, a tire state, a rotational state of a second rotational body, an operational state of the linking body, an operational state of the derailleur, a rotational state of the motor, an electric energy supplied to the motor, a handlebar state, a saddle state, and positional information of the human-powered vehicle.

### CROSS-REFERENCE TO RELATED APPLICATIONS

This application claims priority to Japanese Patent Application No. 2021-214230, filed on Dec. 28, 2021. The entire disclosure of Japanese Patent Application No. 2021-214230 is hereby incorporated herein by reference.

### BACKGROUND

### Technical Field

The present invention generally relates to a control device for a human-powered vehicle.

### Background Information

U.S. patent application Publication No. 2016/0052594 (Patent Document 1) discloses an example of a control device for a human-powered vehicle that performs shifting operations with a derailleur by driving a linking body with a motor.

### SUMMARY

An objective of the present disclosure is to provide a control device for a human-powered vehicle that performs shifting operations with a derailleur in a preferred manner.

A control device in accordance with a first aspect of the present disclosure is for a human-powered vehicle. The human-powered vehicle includes a pair of pedals, a pair of crank arms connected to the pedals, a crank axle connected to the crank arms, a first rotational body connected to the crank axle, a wheel including a tire, a second rotational body connected to the wheel, a linking body engaged with the first rotational body and the second rotational body and configured to transmit driving force between the first rotational body and the second rotational body, a derailleur configured to operate the linking body to change a transmission ratio of a rotational speed of the wheel to a rotational speed of the crank axle, a motor configured to drive the linking body, a handlebar, and a saddle. The control device comprises an electronic controller configured to output a signal to control the motor. The electronic controller is further configured to output a signal to change the transmission ratio by operating the linking body with the derailleur while driving the linking body with the motor in a case where a first condition related to pedaling is satisfied. The first condition includes a condition related to at least one of a state of at least one of the pedals, a human driving force input to at least one of the pedals, a state of at least one of the crank arms, a human driving force input to at least one of the crank arms, an angular acceleration of the crank axle, a rotational state of the first rotational body, a state of the tire, a rotational state of the second rotational body, an operational state of the linking body, an operational state of the derailleur, a rotational state of the motor, an electric energy supplied to the motor, a state of the handlebar, a state of the saddle, and positional information of the human-powered vehicle.

The control device according to the first aspect performs a shifting operation with the derailleur in accordance with the condition related to at least one of the state of at least one of the pedals, the human driving force input to at least one of the pedals, the state of at least one of the crank arms, the human driving force input to at least one of the crank arms, the angular acceleration of the crank axle, the rotational state of the first rotational body, the state of the tire, the rotational state of the second rotational body, the operational state of the linking body, the operational state of the derailleur, the rotational state of the motor, the electric energy supplied to the motor, the state of the handlebar, the state of the saddle, and the positional information of the human-powered vehicle.

In accordance with a second aspect of the present disclosure, the control device according to the first aspect is configured so that the first condition includes a condition related to the angular acceleration of the crank axle, and is satisfied in a case where the angular acceleration of the crank axle is less than or equal to a predetermined angular acceleration.

The control device according to the second aspect changes the transmission ratio by operating the linking body with the derailleur while driving the linking body with the motor in a case where the angular acceleration of the crank axle is less than or equal to the predetermined angular acceleration.

In accordance with a third aspect of the present disclosure, the control device according to the second aspect is configured so that the electronic controller is configured to determine that the condition related to the angular acceleration of the crank axle is satisfied based on a signal received from a first detector that detects the angular acceleration of the crank axle.

The control device according to the third aspect determines whether the first condition is satisfied based on a signal received from the first detector.

In accordance with a fourth aspect of the present disclosure, the control device according to any one of the first to third aspects is configured so that the first condition includes a condition related to the rotational state of the motor. The condition related to the rotational state of the motor includes a condition related to a rotational speed of the motor and is satisfied in a case where the rotational speed of the motor is less than or equal to a predetermined motor rotational speed.

The control device according to the fourth aspect changes the transmission ratio by operating the linking body with the derailleur while driving the linking body with the motor in a case where the rotational speed of the motor is less than or equal to the predetermined motor rotational speed.

In accordance with a fifth aspect of the present disclosure, the control device according to any one of the first to fourth aspects is configured so that the first condition includes a condition related to the rotational state of the motor. The condition related to the rotational state of the motor includes a condition related to a rotational amount of the motor and is satisfied in a case where the rotational amount of the motor is less than or equal to a predetermined motor rotational amount.

The control device according to the fifth aspect changes the transmission ratio by operating the linking body with the derailleur while driving the linking body with the motor in a case where the rotational amount of the motor is less than or equal to the predetermined motor rotational amount.

In accordance with a sixth aspect of the present disclosure, the control device according to the fourth or fifth aspect is configured so that the electronic controller is configured to determine that the condition related to the rotational state of the motor is satisfied based on a signal received from a second detector that detects the rotational state of the motor.

The control device according to the sixth aspect determines whether the first condition is satisfied based on a signal received from the second detector.

In accordance with a seventh aspect of the present disclosure, the control device according to any one of the first to sixth aspects is configured so that the first condition includes a condition related to the electric energy supplied to the motor and is satisfied in a case where a current value of the electric energy is less than or equal to a predetermined current value.

The control device according to the seventh aspect changes the transmission ratio by operating the linking body with the derailleur while driving the linking body with the motor in a case where the current value of the electric energy is less than or equal to the predetermined current value.

In accordance with an eighth aspect of the present disclosure, the control device according to the seventh aspect is configured so that the electronic controller is configured to determine that the condition related to the electric energy supplied to the motor is satisfied based on a signal received from a third detector that detects the electric energy supplied to the motor.

The control device according to the eighth aspect determines whether the first condition is satisfied based on a signal received from the third detector.

In accordance with a ninth aspect of the present disclosure, the control device according to any one of the first to eighth aspects is configured so that the first condition includes a condition related to the rotational state of the first rotational body. The condition related to the rotational state of the first rotational body is satisfied in at least one of a case where a rotational speed of the first rotational body is less than or equal to a first rotational speed and an angular acceleration of the first rotational body is less than or equal to a first angular acceleration.

The control device according to the ninth aspect changes the transmission ratio by operating the linking body with the derailleur while driving the linking body with the motor in at least one of a case where the rotational speed of the first rotational body is less than or equal to the first rotational speed and the angular acceleration of the first rotational body is less than or equal to the first angular acceleration.

In accordance with a tenth aspect of the present disclosure, the control device according to the ninth aspect is configured so that the electronic controller is configured to determine that the condition related to the rotational state of the first rotational body is satisfied based on a signal received from a fourth detector that detects the rotational state of the first rotational body.

The control device according to the tenth aspect determines whether the first condition is satisfied based on a signal received from the fourth detector.

In accordance with an eleventh aspect of the present disclosure, the control device according to any one of the first to tenth aspects is configured so that the first condition includes a condition related to the rotational state of the second rotational body. The condition related to the rotational state of the second rotational body is satisfied in at least one of a case where a rotational speed of the second rotational body is less than or equal to a second rotational speed and an angular acceleration of the second rotational body is less than or equal to a second angular acceleration.

The control device according to the eleventh aspect changes the transmission ratio by operating the linking body with the derailleur while driving the linking body with the motor in at least one of a case where the rotational speed of the second rotational body is less than or equal to the second rotational speed and the angular acceleration of the second rotational body is less than or equal to the second angular acceleration.

In accordance with a twelfth aspect of the present disclosure, the control device according to the eleventh aspect is configured so that the electronic controller is configured to determine that the condition related to the rotational state of the second rotational body is satisfied based on a signal received from a fifth detector that detects the rotational state of the second rotational body.

The control device according to the twelfth aspect determines whether the first condition is satisfied based on a signal received from the fifth detector.

In accordance with a thirteenth aspect of the present disclosure, the control device according to any one of the first to twelfth aspects is configured so that the first condition includes a condition related to the operational state of the linking body. The condition related to the operational state of the linking body is satisfied in a case where a moving speed of the linking body is less than or equal to a predetermined moving speed.

The control device according to the thirteenth aspect changes the transmission ratio by operating the linking body with the derailleur while driving the linking body with the motor in a case where the moving speed of the linking body is less than or equal to the predetermined moving speed.

In accordance with a fourteenth aspect of the present disclosure, the control device according to the thirteenth aspect is configured so that the electronic controller is configured to determine that the condition related to the operational state of the linking body is satisfied based on a signal received from a sixth detector that detects the operational state of the linking body.

The control device according to the fourteenth aspect determines whether the first condition is satisfied based on a signal received from the sixth detector.

In accordance with a fifteenth aspect of the present disclosure, the control device according to any one of the first to fourteenth aspects is configured so that the first condition includes a condition related to the operational state of the derailleur. The derailleur includes a pulley around which the linking body is wound. The condition related to the operational state of the derailleur is satisfied in a case where a rotational speed of the pulley is less than or equal to a predetermined pulley rotational speed.

The control device according to the fifteenth aspect changes the transmission ratio by operating the linking body with the derailleur while driving the linking body with the motor in a case where the rotational speed of the pulley is less than or equal to the predetermined pulley rotational speed.

In accordance with a sixteenth aspect of the present disclosure, the control device according to the fifteenth aspect is configured so that the electronic controller is configured to determine that the condition related to the operational state of the derailleur is satisfied based on a signal received from a seventh detector that detects the rotational speed of the pulley.

The control device according to the sixteenth aspect determines whether the first condition is satisfied based on a signal received from the seventh detector.

In accordance with a seventeenth aspect of the present disclosure, the control device according to any one of the first to sixteenth aspects is configured so that the first condition includes a condition related to the operational state of the derailleur. The derailleur includes a base and an operation portion. The base is provided on a frame of the human-powered vehicle. The operation portion is attached to the base and movable relative to the base. The condition related to the operational state of the derailleur is satisfied in a case where an operational state of the operation portion is a predetermined operational state.

The control device according to the seventeenth aspect changes the transmission ratio by operating the linking body with the derailleur while driving the linking body with the motor in a case where the operational state of the operation portion is the predetermined operational state.

In accordance with an eighteenth aspect of the present disclosure, the control device according to the seventeenth aspect is configured so that the electronic controller is configured to determine that the condition related to the operational state of the derailleur is satisfied based on a signal received from an eighth detector that detects the operational state of the operation portion.

The control device according to the eighteenth aspect determines whether the first condition is satisfied based on a signal received from the eighth detector.

In accordance with a nineteenth aspect of the present disclosure, the control device according to any one of the first to eighteenth aspects is configured so that the first condition includes a condition related to the state of the at least one of the crank arms. The condition related to the state of the crank arm includes a condition related to a rotational state of the at least one of the crank arms. The condition related to the rotational state of the crank arm is satisfied in a case where the rotational state of the at least one of the crank arms is a predetermined rotational state.

The control device according to the nineteenth aspect changes the transmission ratio by operating the linking body with the derailleur while driving the linking body with the motor in a case where the rotational state of the at least one of the crank arms is the predetermined rotational state.

In accordance with a twentieth aspect of the present disclosure, the control device according to the nineteenth aspect is configured so that the electronic controller is configured to determine that the condition related to the rotational state of the at least one of the crank arms is satisfied based on a signal received from a ninth detector that detects the rotational state of the at least one of the crank arms.

The control device according to the twentieth aspect determines whether the first condition is satisfied based on a signal received from the ninth detector.

In accordance with a twenty-first aspect of the present disclosure, the control device according to any one of the first to twentieth aspects is configured so that the first condition includes a condition related to the human driving force input to the at least one of the crank arms. The condition related to the human driving force input to the at least one of the crank arms is satisfied in a case where the human driving force input to the at least one of the crank arms is less than or equal to a predetermined human driving force.

The control device according to the twenty-first aspect changes the transmission ratio by operating the linking body with the derailleur while driving the linking body with the motor in a case where the human driving force input to the at least one of the crank arms is less than or equal to the predetermined human driving force.

In accordance with a twenty-second aspect of the present disclosure, the control device according to the twenty-first aspect is configured so that the electronic controller is configured to determine that the condition related to the human driving force input to the at least one of the crank arms is satisfied based on a signal received from a tenth detector. The tenth detector detects the human driving force input to the at least one of the crank arms and is provided on at least one of the at least one of the crank arms and the at least one of the pedals of the human-powered vehicle.

The control device according to the twenty-second aspect determines whether the first condition is satisfied based on a signal received from the tenth detector.

In accordance with a twenty-third aspect of the present disclosure, the control device according to any one of the first to twenty-second aspects is configured so that the electronic controller is configured to determine that the first condition is satisfied based on a predetermined signal received from an eleventh detector. The eleventh detector is configured to output the predetermined signal in a case where a rotational phase of at least one of the at least one of the crank arms and the crank axle is a predetermined rotational phase.

The control device according to the twenty-third aspect changes the transmission ratio by operating the linking body with the derailleur while driving the linking body with the motor in a case where the rotational phase of at least one of the crank arm and the crank axle is the predetermined rotational phase. The control device according to the twenty-third aspect determines whether the first condition is satisfied based on a signal received from the eleventh detector.

A control device in accordance with a twenty-fourth aspect of the present disclosure is for a human-powered vehicle. The human-powered vehicle includes a pair of crank arms that receives a human driving force, a crank axle connected to the crank arms, a first rotational body connected to the crank axle, a wheel, a second rotational body connected to the wheel, a linking body engaged with the first rotational body and the second rotational body and configured to transmit driving force between the first rotational body and the second rotational body, a derailleur configured to operate the linking body to change a transmission ratio of a rotational speed of the wheel to a rotational speed of the crank axle, and a motor configured to drive the linking body. The control device comprises an electronic controller configured to output a signal to control the motor. The electronic controller is further configured to output a signal to change the transmission ratio by operating the linking body with the derailleur while driving the linking body with the motor in a case where a first condition related to pedaling is satisfied. The electronic controller is further configured to determine that the first condition is satisfied based on a signal received from a predetermined detector that is at least one of a plurality of detectors. The electronic controller is further configured to switch the predetermined detector in accordance with a second condition.

The control device according to the twenty-fourth aspect switches the predetermined detector in accordance with the second condition. This facilitates shifting operations with the derailleur.

In accordance with a twenty-fifth aspect of the present disclosure, the control device according to the twenty-fourth aspect is configured so that the second condition includes a condition related to an anomaly in the plurality of detectors.

The control device according to the twenty-fifth aspect switches the predetermined detector in a case where the condition related to an anomaly in the detectors is satisfied. This facilitates shifting operations with the derailleur.

A control device in accordance with a twenty-sixth aspect of the present disclosure is for a human-powered vehicle. The human-powered vehicle includes a crank axle, a first rotational body connected to the crank axle, a wheel, a second rotational body connected to the wheel, a linking body engaged with the first rotational body and the second rotational body and configured to transmit driving force between the first rotational body and the second rotational body, a derailleur configured to operate the linking body to change a transmission ratio of a rotational speed of the wheel to a rotational speed of the crank axle, and a motor configured to drive the linking body. The human-powered vehicle further includes at least one of a suspension and an adjustable seatpost. The control device comprises an electronic controller configured to output a signal to control the motor. The electronic controller is further configured to output a signal to change the transmission ratio by operating the linking body with the derailleur while driving the linking body with the motor in a case where a first condition related to pedaling is satisfied. The first condition includes a condition related to at least one of a state of the suspension and a state of the adjustable seatpost.

The control device according to the twenty-sixth aspect performs a shifting operation with the derailleur in accordance with the condition related to at least one of the state of the suspension and the state of the adjustable seatpost.

A control device in accordance with a twenty-seventh aspect of the present disclosure is for a human-powered vehicle. The human-powered vehicle includes drive train elements including a crank axle, a first rotational body connected to the crank axle, a wheel, a second rotational body connected to the wheel, and a linking body engaged with the first rotational body and the second rotational body and configured to transmit driving force between the first rotational body and the second rotational body. The human-powered vehicle further includes a derailleur configured to operate the linking body to change a transmission ratio of a rotational speed of the wheel to a rotational speed of the crank axle, and a motor configured to drive the linking body. The control device comprises an electronic controller configured to output a signal to control the motor. The electronic controller is further configured to output a signal to change the transmission ratio by operating the linking body with the derailleur while driving the linking body with the motor in a case where a first condition related to pedaling is satisfied. The first condition includes a condition related to a driving force transmission state between two adjacent ones of the drive train elements.

The control device according to the twenty-seventh aspect performs a shifting operation with the derailleur in accordance with the condition related to the driving force transmission state between two adjacent ones of the drive train elements.

The human-powered vehicle control device in accordance with the present disclosure performs shifting operations with the derailleur in a preferred manner.

### BRIEF DESCRIPTION OF THE DRAWINGS

Referring now to the attached drawings which form a part of this original disclosure.

FIG. 1 is a side elevational view of a human-powered vehicle including a human-powered vehicle control device in accordance with a first embodiment.

FIG. 2 is a block diagram illustrating the electrical configuration of the human-powered vehicle shown in FIG. 1.

FIG. 3 is a cross-sectional view of a human-powered vehicle drive unit shown in FIG. 1.

FIG. 4 is a schematic diagram of an electric circuit including a third detector illustrated in FIG. 2.

FIG. 5 is an exploded perspective view of a sixth detector illustrated in FIG. 2 and a human-powered vehicle hub.

FIG. 6 is a front view of a seventh detector and a derailleur illustrated in FIG. 2.

FIG. 7 is a front view showing the structure of an eighth detector and an electric actuator of the derailleur illustrated in FIG. 2.

FIG. 8 is a perspective view of the eighth detector and the electric actuator of the derailleur shown in FIG. 7.

FIG. 9 is a front view of a crank arm, a first rotational body, and an example of a tenth detector illustrated in FIG. 2.

FIG. 10 is a front view of a pedal, the crank arm, and another example of the tenth detector illustrated in FIG. 2.

FIG. 11 is a flowchart illustrating a process executed by a controller illustrated in FIG. 2 to control a motor and the derailleur.

FIG. 12 is a block diagram illustrating the electrical configuration of a human-powered vehicle in accordance with a second embodiment.

FIG. 13 is a flowchart illustrating a process executed by a controller in accordance with a third embodiment to control a predetermined detector.

### DETAILED DESCRIPTION OF EMBODIMENTS

Selected embodiments will now be explained with reference to the drawings. It will be apparent to those skilled in the bicycle field from this disclosure that the following descriptions of the embodiments are provided for illustration only and not for the purpose of limiting the invention as defined by the appended claims and their equivalents.

### First Embodiment

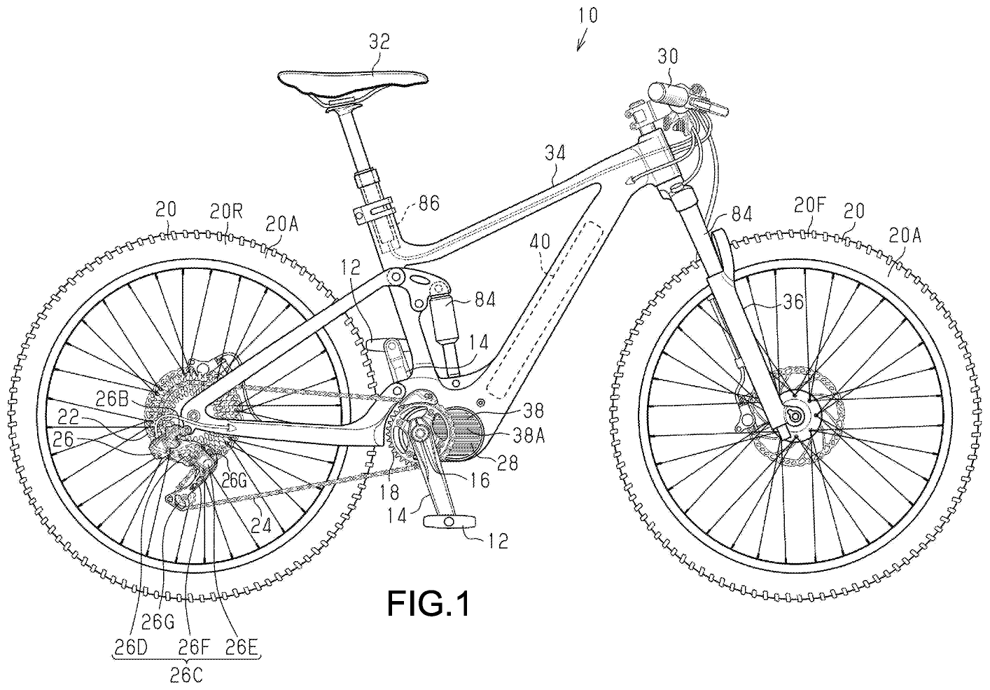

A control device 90 for a human-powered vehicle in accordance with the present disclosure will now be described with reference to FIGS. 1 to 11. A human-powered vehicle is a vehicle that includes at least one wheel and can be driven by at least human driving force. Examples of the human-powered vehicle include various types of bicycles such as a mountain bike, a road bike, a city bike, a cargo bike, a handcycle, and a recumbent bike. There is no limit to the number of wheels of the human-powered vehicle. The human-powered vehicle also includes, for example, a unicycle or a vehicle having two or more wheels. The human-powered vehicle is not limited to a vehicle that can be driven only by a human driving force. The human-powered vehicle includes an electric bicycle (E-bike) that uses drive force of an electric motor for propulsion in addition to a human driving force. The E-bike includes an electric assist bicycle that assists in propulsion with an electric motor. In the embodiment described hereafter, the human-powered vehicle will be described as an electric assist bicycle.

As shown in FIG. 1, a human-powered vehicle 10 includes a pair of pedals 12, a pair of crank arms 14, a crank axle 16, a first rotational body 18, at least one wheel 20, a second rotational body 22, a linking body 24, a derailleur 26, a motor 28, a handlebar 30, and a saddle 32. The crank arm 14 is connected to the pedals 12. The crank axle 16 is connected to the crank arm 14. The first rotational body 18 is connected to the crank axle 16. The wheel 20 includes a tire 20A. The second rotational body 22 is connected to the wheel 20. The linking body 24 is engaged with the first rotational body 18 and the second rotational body 22, and is configured to transmit driving force between the first rotational body 18 and the second rotational body 22. The derailleur 26 is configured to operate the linking body 24 to change a transmission ratio R of a rotational speed of the wheel 20 to a rotational speed of the crank axle 16. The motor 28 is configured to drive the linking body 24.

The wheel 20 includes a rear wheel 20R and a front wheel 20F. The second rotational body 22 is connected to the rear wheel 20R. The human-powered vehicle 10 further includes a frame 34. The frame 34 includes, for example, at least one of a top tube, a down tube, a seat tube, a seat stay, and a chainstay. The human-powered vehicle 10 further includes a front fork 36.

The rear wheel 20R is driven by the rotation of the crank axle 16. The rear wheel 20R is supported by the frame 34. The crank axle 16 and the first rotational body 18 can be coupled to rotate integrally with each other or coupled by a first one-way clutch 38B. The first one-way clutch 38B is configured to rotate the first rotational body 18 forward in a case where the crank axle 16 is rotated forward and allow relative rotation of the crank axle 16 and the first rotational body 18 in a case where the crank axle 16 is rotated rearward. The first rotational body 18 includes a sprocket, a pulley, or a bevel gear. The linking body 24 transmits the rotational force of the first rotational body 18 to the second rotational body 22. The linking body 24 includes, for example, a chain, a belt, or a shaft.

The second rotational body 22 includes a sprocket, a pulley, or a bevel gear. Preferably, a second one-way clutch is provided between the second rotational body 22 and the rear wheel 20R. The second one-way clutch is configured to rotate the rear wheel 20R forward in a case where the second rotational body 22 is rotated forward and allow relative rotation of the second rotational body 22 and the rear wheel 20R in a case where the second rotational body 22 is rotated rearward.

The front wheel 20F is attached to the frame 34 by the front fork 36. The handlebar 30 is connected to the front fork 36 by a stem.

The human-powered vehicle 10 receives the propulsion force applied by a drive unit 38 that includes the motor 28. The motor 28 is, for example, a brushless motor. The motor 28 is configured to transmit rotational force to a power transmission path of the human driving force extending from the pedals 12 to the second rotational body 22. In the present embodiment, the motor 28 is provided on the frame 34 of the human-powered vehicle 10 and configured to transmit rotational force to the first rotational body 18.

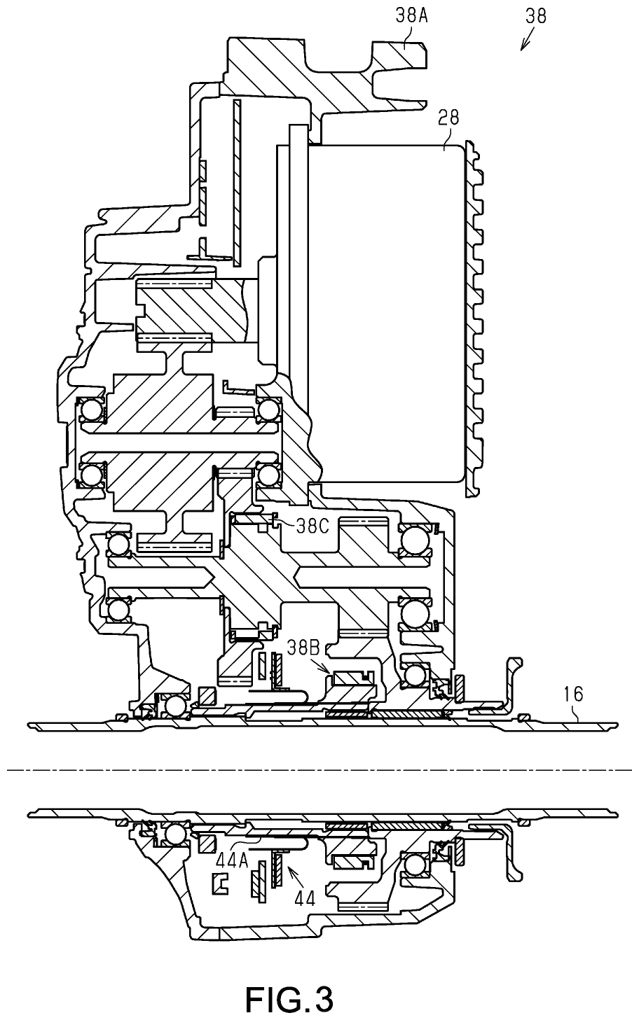

As shown in FIGS. 1 and 3, the drive unit 38 further includes a housing 38A. The motor 28 is provided in the housing 38A of the drive unit 38. The housing 38A is provided on the frame 34. In an example, the housing 38A is attached to the frame 34 in a detachable manner. The drive unit 38 can include a speed reducer connected to an output shaft of the motor 28. In the present embodiment, the housing 38A rotatably supports the crank axle 16. In the present embodiment, it is preferred that a third one-way clutch 38C be provided in the power transmission path between the motor 28 and the crank axle 16 to restrict transmission of the rotational force of the crank axle 16 to the motor 28 in a case where the crank axle 16 is rotated in a direction in which the human-powered vehicle 10 moves forward.

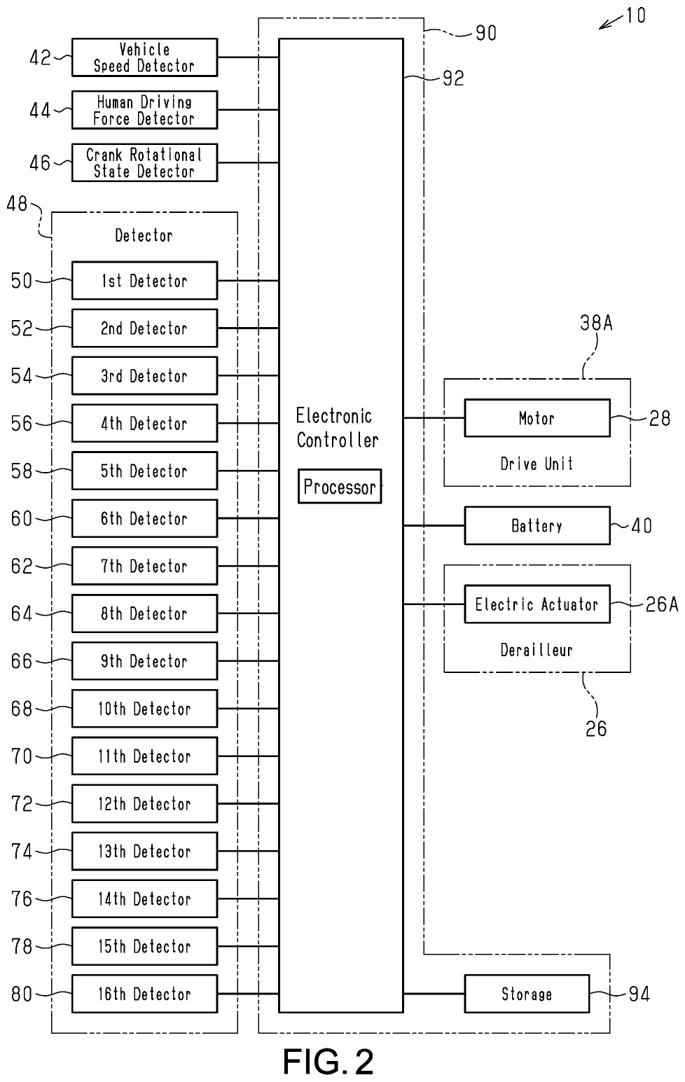

The derailleur 26 shown in FIGS. 1 and 2 is provided in the transmission path of the human driving force in the human-powered vehicle 10, and is configured to change the transmission ratio R. The derailleur 26 includes transmission stages. The transmission stages differ from one another in the corresponding transmission ratio R. The number of transmission stages is, for example, in a range of three to thirty. The derailleur 26 is configured to change the transmission ratio R that is a ratio of the rotational speed of the drive wheel to the rotational speed of the crank axle 16. In the present embodiment, the drive wheel is the rear wheel 20R. The derailleur 26 includes, for example, at least one of a front derailleur and a rear derailleur.

In a case where the derailleur 26 includes a front derailleur, the first rotational body 18 includes a plurality of front sprockets. In a case where the derailleur 26 includes a rear derailleur, the second rotational body 22 includes a plurality of rear sprockets. In an example, the derailleur 26 includes an electric actuator 26A and is configured to be actuated by the electric actuator 26A. The electric actuator 26A includes, for example, an electric motor. The relationship of the transmission ratio R, the rotational speed of the drive wheel, and the rotational speed of the crank axle 16 satisfies the following equation (1).

transmission ratio R=rotational speed of drive wheel/rotational speed of crank axle 16 Equation (1)

The rotational speed of the drive wheel and the rotational speed of the crank axle 16 can each be the number of rotations per unit time. The rotational speed of the drive wheel can be replaced by the number of teeth of the front sprocket, and the rotational speed of the crank axle 16 can be replaced by the number of teeth of the rear sprocket.

As shown in FIG. 1, for example, the derailleur 26 includes a base 26B and an operation portion 26C. The base 26B is provided on the frame 34 of the human-powered vehicle 10. The operation portion 26C is attached to the base 26B and movable relative to the base 26B. The operation portion 26C includes, for example, at least one of a link portion 26D, a movable portion 26E, and a plate 26F. In an example, the derailleur 26 includes a pulley 26G around which the linking body 24 is wound. The pulley 26G is provided on the plate 26F. In a case where the derailleur 26 includes a rear derailleur, the derailleur 26 includes, for example, two pulleys 26G.

In an example, the human-powered vehicle 10 further includes a battery 40. The battery 40 includes one or more battery cells. Each battery cell includes a rechargeable battery. In an example, the battery 40 is configured to supply electric power to the drive unit 38. In an example, the battery 40 is connected to the drive unit 38 in a manner allowing for wired communication or wireless communication. The battery 40 is configured to perform communication with the drive unit 38 through, for example, power line communication (PLC), Controller Area Network (CAN), or Universal Asynchronous Receiver/Transmitter (UART).

As shown in FIG. 2, the control device 90 includes an electronic controller 92. The electronic controller 92 includes at least one processor that executes predetermined control programs. The processor of the electronic controller 92 include, for example, a central processing unit (CPU) or a micro-processing unit (MPU). The electronic controller 92 can include a plurality of processor provided at separate positions. The electronic controller 92 can include one or more microcomputers. The electronic controller 92 is formed of one or more semiconductor chips that are mounted on a circuit board. Thus, the terms “electronic controller” and “controller” as used herein refers to hardware that executes a software program, and does not include a human being.

In an example, the control device 90 further includes storage 94. The storage 94 is any computer storage device or any non-transitory computer-readable medium with the sole exception of a transitory, propagating signal. The storage 94 stores predetermined control programs and information used for control processes. The storage 94 includes, for example, a nonvolatile memory and a volatile memory. The non-volatile memory includes, for example, at least one of a read-only memory (ROM), an erasable programmable read-only memory (EPROM), an electrically erasable programmable read-only memory (EEPROM), and a flash memory. The volatile memory includes, for example, a random-access memory (RAM). The electronic controller 92 stores and reads data and/or programs from the storage 94.

In an example, the electronic controller 92 includes a drive circuit of the motor 28. The drive circuit includes, for example, an inverter. In an example, the electronic controller 92 is configured to control the motor 28 and apply a propulsion force to the human-powered vehicle 10 in accordance with at least one of a traveling state and a traveling environment of the human-powered vehicle 10. In an example, the electronic controller 92 is configured to control the motor 28 and apply a propulsion force to the human-powered vehicle 10 in accordance with an output of at least one of a vehicle speed detector 42, a human driving force detector 44, and a crank rotational state detector 46. The term “detector” as used herein refers to a hardware device or instrument designed to detect the presence or absence of a particular event, object, substance, or a change in its environment, and to emit a signal in response. The term “detector” as used herein does not include a human being.

The vehicle speed detector 42 is configured to detect information related to speed of the human-powered vehicle 10. In the present embodiment, the vehicle speed detector 42 is configured to detect information related to a rotational speed of at least one wheel 20 of the human-powered vehicle 10. In an example, the vehicle speed detector 42 is configured to detect a magnet provided on at least one wheel 20 of the human-powered vehicle 10. In an example, the vehicle speed detector 42 is configured to output a predetermined number of detection signals during a period in which one of the at least one wheel 20 completes one rotation. The predetermined number is, for example, one. The vehicle speed detector 42 outputs a signal corresponding to the rotational speed of the wheel 20. The electronic controller 92 can calculate the speed of the human-powered vehicle 10 based on the signal corresponding to the rotational speed of the wheel 20 and information related to the circumferential length of the wheel 20. In an example, the electronic controller 92 stores the information related to the circumferential length of the wheel 20.

The human driving force detector 44 is configured to detect information related to a human driving force. In an example, the human driving force detector 44 is provided on the frame 34, the drive unit 38, the crank axle 16, or the pedal 12 of the human-powered vehicle 10.

As shown in FIG. 3, the human driving force detector 44 can be provided in the housing 38A of the drive unit 38. The human driving force detector 44 includes, for example, a torque sensor 44A. The torque sensor 44A is configured to output a signal corresponding to a torque applied to the crank axle 16 by a human driving force. In an example in which the first one-way clutch 38B is provided in the power transmission path, it is preferred that the torque sensor 44A be provided at an upstream side of the first one-way clutch 38B in the power transmission path. The torque sensor 44A includes a strain sensor, a magnetostrictive sensor, a pressure sensor, or the like. A strain sensor includes a strain gauge.

The torque sensor 44A is provided on a member included in the power transmission path or in the vicinity of the member included in the power transmission path. The member included in the power transmission path is, for example, the crank axle 16, a member that transmits the human driving force between the crank axle 16 and the first rotational body 18, the crank arm 14, or the pedal 12. The human driving force detector 44 can have any configuration as long as information related to the human driving force is obtained. For example, the human driving force detector 44 can include a sensor that detects the pressure applied to the pedal 12, a sensor that detects the tension on the chain, or the like. The human driving force detector 44 can be included in the drive unit 38.

The crank rotational state detector 46 is configured to detect information related to the rotational speed of the crank axle 16. The crank rotational state detector 46 is provided on, for example, the frame 34 or the drive unit 38 of the human-powered vehicle 10. The crank rotational state detector 46 can be provided on the housing 38A of the drive unit 38. The crank rotational state detector 46 includes a magnetic sensor that outputs a signal corresponding to the strength of a magnetic field. A ring-shaped magnet of which the magnetic field changes in a circumferential direction is provided on the crank axle 16, a member that is rotated in cooperation with the crank axle 16, or in the power transmission path extending from the crank axle 16 to the first rotational body 18. The member that is rotated in cooperation with the crank axle 16 can include the output shaft of the motor 28.

The crank rotational state detector 46 outputs a signal corresponding to the rotational speed of the crank axle 16. In an example in which the first one-way clutch 38B is not provided between the crank axle 16 and the first rotational body 18, the magnet can be provided on the first rotational body 18. The crank rotational state detector 46 can have any configuration as long as information related to the rotational speed of the crank axle 16 is obtained. The crank rotational state detector 46 can include an optical sensor, an acceleration sensor, a gyro sensor, a torque sensor, or the like instead of the magnetic sensor. The crank rotational state detector 46 can be included in the drive unit 38.

The configuration of the electronic controller 92 will now be described with reference to FIGS. 1 and 2. The electronic controller 92 is configured to output a signal to control the motor 28. The electronic controller 92 is configured to output a signal to change the transmission ratio R by operating the linking body 24 with the derailleur 26 while driving the linking body 24 with the motor 28 in a case where a first condition related to pedaling is satisfied. The first condition includes a condition related to at least one of a state of the pedal 12, a human driving force input to the pedal 12, a state of the crank arm 14, a human driving force input to the crank arm 14, an angular acceleration of the crank axle 16, a rotational state of the first rotational body 18, a state of the tire 20A, a rotational state of the second rotational body 22, an operational state of the linking body 24, an operational state of the derailleur 26, a rotational state of the motor 28, an electric energy supplied to the motor 28, a state of the handlebar 30, a state of the saddle 32, and positional information of the human-powered vehicle 10.

In an example, the electronic controller 92 is configured to change the transmission ratio R by operating the linking body 24 with the derailleur 26 while driving the linking body 24 with the motor 28 in a case where the state of the linking body 24 is not suitable for a shifting operation with the derailleur 26.

In an example, the first condition is set to a condition that allows for determination of whether the state of the linking body 24 is suitable for a shifting operation with the derailleur 26. In an example, the first condition is set to be satisfied in a case where the state of the linking body 24 is unsuitable for a shifting operation with the derailleur 26. A case where the state of the linking body 24 is unsuitable for a shifting operation with the derailleur 26 is a state in which the crank axle 16 is not rotated by a human driving force. Thus, driving force is not applied to the linking body 24, and the linking body 24 cannot be moved relative to the first rotational body 18 and the second rotational body 22. A case where the state of the linking body 24 is unsuitable for a shifting operation with the derailleur 26 can include a state in which the motor 28 applies no driving force to the linking body 24. Thus, the linking body 24 cannot be moved relative to the first rotational body 18 and the second rotational body 22.

In an example, the electronic controller 92 is configured to change the transmission ratio R by operating the linking body 24 with the derailleur 26 while driving the linking body 24 with the motor 28 in a case where a shifting condition is satisfied and the first condition is satisfied. In an example, the shifting condition is satisfied in a case where a transmission operating device is operated. In an example, the shifting condition is satisfied in accordance with at least one of the traveling state and the traveling environment of the human-powered vehicle 10. In an example, the shifting condition is satisfied in a case where the human-powered vehicle 10 is expected to stop. In an example, the electronic controller 92 is configured to determine that the shifting condition is satisfied in a case where the vehicle speed of the human-powered vehicle 10 is less than or equal to a predetermined vehicle speed. In an example, the electronic controller 92 determines that the shifting condition is satisfied in accordance with the gradient of the road on which the human-powered vehicle 10 is traveling. The shifting condition can include at least one of a first shifting condition that increases the transmission ratio R and a second shifting condition that decreases the transmission ratio R.

As shown in FIG. 2, the human-powered vehicle 10 further includes, for example, a detector 48 that detects a parameter for determining whether the first condition is satisfied. In an example, the electronic controller 92 is configured to determine whether the first condition is satisfied based on an output of the detector 48. In a case where the first condition is satisfied, the electronic controller 92 changes the transmission ratio R by operating the linking body 24 with the derailleur 26 while driving the linking body 24 with the motor 28.

The first condition includes at least one of a first example, second example, third example, fourth example, fifth example, sixth example, seventh example, eighth example, ninth example, tenth example, eleventh example, twelfth example, thirteenth example, fourteenth example, fifteenth example, sixteenth example, and seventeenth example. In an example in which the first condition includes two or more of the first to seventeenth examples, the electronic controller 92 is configured to change the transmission ratio R by operating the linking body 24 with the derailleur 26 while driving the linking body 24 with the motor 28 in a case where a condition related to one example included in the first condition is satisfied.

In an example, the human-powered vehicle 10 includes a detector 48 that corresponds to each example of the first condition. In an example in which the first condition includes the first example, the detector 48 includes a first detector 50. In an example in which the first condition includes at least one of the second and third examples, the detector 48 includes a second detector 52. In an example in which the first condition includes the fourth example, the detector 48 includes a third detector 54. In an example in which the first condition includes the fifth example, the detector 48 includes a fourth detector 56. In an example in which the first condition includes the sixth example, the detector 48 includes a fifth detector 58.

In an example in which the first condition includes the seventh example, the detector 48 includes a sixth detector 60. In an example in which the first condition includes the eighth example, the detector 48 includes a seventh detector 62. In an example in which the first condition includes the ninth example, the detector 48 includes an eighth detector 64. In an example in which the first condition includes the tenth example, the detector 48 includes a ninth detector 66. In an example in which the first condition includes the eleventh example, the detector 48 includes a tenth detector 68.

In an example in which the first condition includes the twelfth example, the detector 48 includes an eleventh detector 70. In an example in which the first condition includes the thirteenth example, the detector 48 includes a twelfth detector 72. In an example in which the first condition includes the fourteenth example, the detector 48 includes a thirteenth detector 74. In an example in which the first condition includes the fifteenth example, the detector 48 includes a fourteenth detector 76. In an example in which the first condition includes the sixteenth example, the detector 48 includes a fifteenth detector 78. In an example in which the first condition includes the seventeenth example, the detector 48 includes a sixteenth detector 80. As long as the detector 48 includes a detector that corresponds to each example of the first condition used by the electronic controller 92, the detector 48 does not have to include another.

Table 1 illustrates the relationship of a detector type used in each example of the first condition and a specific example in which the first condition is satisfied. The specific example in which the first condition is satisfied is used for determining that the state of the linking body 24 is unsuitable for a shifting operation with the derailleur 26. In an example, the electronic controller 92 is configured to change the transmission ratio R by operating the linking body 24 with the derailleur 26 while driving the linking body 24 with the motor 28 in a case where a first condition that corresponds to a predetermined one of the first to seventeenth examples is satisfied. The electronic controller 92 can be configured to change the transmission ratio R by operating the linking body 24 with the derailleur 26 while driving the linking body 24 with the motor 28 in a case where first conditions that correspond to two or more predetermined ones of the first to seventeenth examples are all satisfied.

TABLE 1

| | Detector | Specific Example of 1st Condition |
|---|---|---|
| 1st Example | 1st Detector | Angular Acceleration of Crank Axle ≤ |
| | | Predetermined Angular Acceleration |
| 2nd Example | 2nd Detector | Rotational Speed of Motor ≤ |
| | | Predetermined Motor Rotational Speed |
| 3rd Example | 2nd Detector | Rotational Amount of Motor ≤ |
| | | Predetermined Rotational Amount |
| 4th Example | 3rd Detector | Electric Energy Current Value ≤ |
| | | Predetermined Current Value |
| 5th Example | 4th Detector | Rotational Speed of 1st Rotational |
| | | Body ≤ 1st Rotational Speed |
| | 4th Detector | Angular Acceleration of 1st Rotational |
| | | Body ≤ 1st Angular Acceleration |
| 6th Example | 5th Detector | Rotational Speed of 2nd Rotational |
| | | Body ≤ 2nd Rotational Speed |
| | 5th Detector | Angular Acceleration of 2nd Rotational |
| | | Body ≤ 2nd Angular Acceleration |
| 7th Example | 6th Detector | Moving Speed of Linking Body ≤ |
| | | Predetermined Moving Speed |
| 8th Example | 7th Detector | Rotational Speed of Pulley ≤ |
| | | Predetermined Pulley Rotational Speed |
| 9th Example | 8th Detector | Operational State of Operation |
| | | Portion = Predetermined Operational |
| | | State |
| 10th Example | 9th Detector | Rotational State of Crank Arm = |
| | | Predetermined Rotational State |
| 11th Example | 10th Detector | Human Driving Force Input to Crank |
| | | Arm ≤ Predetermined Human Driving |
| | | Force |
| 12th Example | 11th Detector | Rotational Phase of At Least One of |
| | | Crank Arm and Crank Axle = |
| | | Predetermined Rotational Phase |
| 13th Example | 12th Detector | State of Pedal = Predetermined Pedal |
| | | State |
| 14th Example | 13th Detector | State of Tire = Predetermined Tire State |
| 15th Example | 14th Detector | State of Handlebar = Predetermined |
| | | Handlebar State |
| 16th Example | 15th Detector | State of Saddle = Predetermined Saddle |
| | | State |
| 17th Example | 16th Detector | Traveling Distance of Human-Powered |
| | | Vehicle Per Predetermined Time ≤ |
| | | Predetermined Distance |

In the first example of the first condition, the first condition includes a condition related to an angular acceleration of the crank axle 16 and is satisfied in a case where the angular acceleration of the crank axle 16 is less than or equal to a predetermined angular acceleration. In an example, the predetermined angular acceleration is set to a value allowing for determination that the crank axle 16 is not rotated by a human driving force. In an example, the predetermined angular acceleration is zero or a value approximate to zero.

In the first example of the first condition, the electronic controller 92 is configured to determine that the condition related to the angular acceleration of the crank axle 16 is satisfied based on a signal received from the first detector 50 that detects the angular acceleration of the crank axle 16.

In an example, the first detector 50 includes an acceleration sensor provided on the crank axle 16. The first detector 50 can have the same configuration as the crank rotational state detector 46, and the electronic controller 92 can be configured to obtain the angular acceleration of the crank axle 16 by differentiating the rotational speed of the crank axle 16. The first detector 50 can include an acceleration sensor provided on the crank arm 14.

In the second example of the first condition, the first condition includes a condition related to the rotational state of the motor 28. The condition related to the rotational state of the motor 28 includes a condition related to a rotational speed of the motor 28 and is satisfied in a case where the rotational speed of the motor 28 is less than or equal to a predetermined motor rotational speed. In an example, the predetermined motor rotational speed is set to a value allowing for determination that the linking body 24 receives no driving force of the motor 28. In an example, the predetermined motor rotational speed is zero or a value approximate to zero. The electronic controller 92 is configured to control the motor 28 in accordance with a human driving force in a case where an assist mode is on. Therefore, in a state in which the assist mode is on and the crank axle 16 is not rotated by a human driving force, the rotational speed of the motor 28 becomes less than or equal to the predetermined motor rotational speed.

In the third example of the first condition, the first condition includes the condition related to the rotational state of the motor 28. The condition related to the rotational state of the motor 28 includes a condition related to a rotational amount of the motor 28 and is satisfied in a case where the rotational amount of the motor 28 is less than or equal to a predetermined motor rotational amount. In an example, the predetermined motor rotational amount is set to a value allowing for determination that the linking body 24 receives no driving force of the motor 28. In an example, the predetermined motor rotational amount is the rotational amount of the motor 28 per unit time. In an example, the predetermined motor rotational amount is zero or a value approximate to zero. The electronic controller 92 is configured to control the motor 28 in accordance with the human driving force in a case where the assist mode is on. Therefore, in a state in which the assist mode is on and the crank axle 16 is not rotated by a human driving force, the rotational amount of the motor 28 becomes less than or equal to the predetermined motor rotational amount.

In the second and third examples of the first condition, the electronic controller 92 is configured to determine that the condition related to the rotational state of the motor 28 is satisfied based on a signal received from the second detector 52 that detects the rotational state of the motor 28.

In an example, the second detector 52 is configured to detect the magnetic field of a magnet provided on a rotor of the motor 28. In an example, the second detector 52 is a resolver. The second detector 52 can be configured to detect a rotational speed of the output shaft of the motor 28. In an example in which the second detector 52 is configured to detect the rotational speed of the output shaft of the motor 28, the second detector 52 is configured to detect the magnetic field of a magnet provided on the output shaft. The second detector 52 can be configured to detect the rotational speed of a predetermined rotational body provided between the motor 28 and the first rotational body 18. In an example in which the second detector 52 is configured to detect the rotational speed of the predetermined rotational body, the second detector 52 is configured to detect the magnetic field of a magnet provided on the predetermined rotational body. In an example, the predetermined rotational body is part of a speed reducer that reduces the speed of rotation of the motor 28 and transmits the rotation to the first rotational body 18.

In the fourth example of the first condition, the first condition includes a condition related to the electric energy supplied to the motor 28 and is satisfied in a case where the current value of the electric energy is less than or equal to a predetermined current value. In an example, the predetermined current value is set to a value allowing for detection of a no-load state of the motor 28. The value that allows for detection of a no-load state of the motor 28 is, for example, 0.3 A. In an example, the predetermined current value is set to a value at which the motor 28 cannot propel the human-powered vehicle 10. The value at which the motor 28 cannot propel the human-powered vehicle 10 is, for example, 1 A.

In the fourth example of the first condition, the electronic controller 92 is configured to determine that the condition related to the electric energy supplied to the motor 28 is satisfied based on a signal received from the third detector 54 that detects the electric energy supplied to the motor 28.

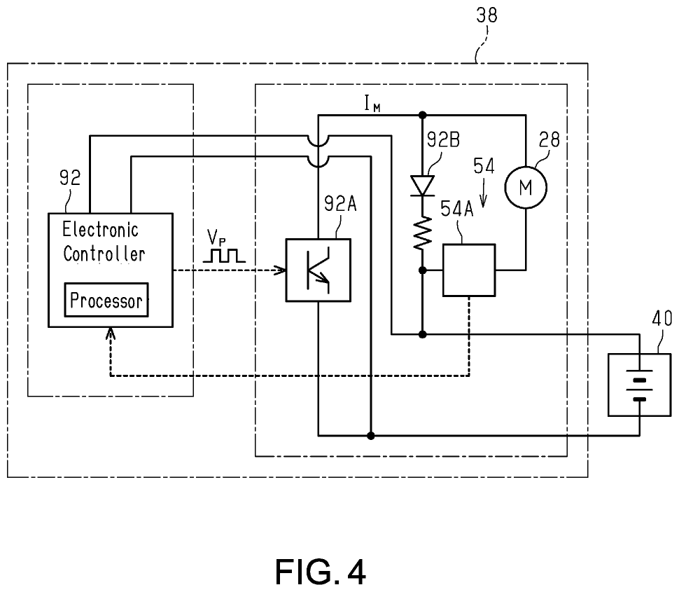

As shown in FIG. 4, the third detector 54 includes, for example, a current sensor 54A. In an example, the current sensor 54A is provided in the wiring extending between the motor 28 and the battery 40. The electronic controller 92 is configured to control the supply of electric power from the battery 40 to the motor 28 by controlling a transistor 92A. In an example, a closed circuit 92B is provided in parallel to the motor 28 in the control circuit of the motor 28. The closed circuit 92B is formed by coupling a resistor and a flyback diode. In a case where deactivation of the transistor 92A results in current interruption, the closed circuit 92B acts to gradually change the voltage of the motor 28. In an example, the current sensor 54A is located closer to the motor 28 than the closed circuit 92B in the series circuit extending from the battery 40 to the motor 28.

In the fifth example of the first condition, the first condition includes a condition related to the rotational state of the first rotational body 18. The condition related to the rotational state of the first rotational body 18 is satisfied in at least one of a case where a rotational speed of the first rotational body 18 is less than or equal to a first rotational speed and an angular acceleration of the first rotational body 18 is less than or equal to a first angular acceleration. In an example, the first rotational speed and the first angular acceleration are set to values allowing for determination that the crank axle 16 is not rotated by a human driving force. In an example, the first rotational speed and the first angular acceleration are zero or a value approximate to zero.

In the fifth example of the first condition, the electronic controller 92 is configured to determine that the condition related to the rotational state of the first rotational body 18 is satisfied based on a signal received from the fourth detector 56 that detects the rotational state of the first rotational body 18.

In an example, the fourth detector 56 is configured to detect the magnetic field of a magnet provided on the first rotational body 18. In an example, the fourth detector 56 is provided on the frame 34. The fourth detector 56 can be provided on the housing 38A of the drive unit 38. The fourth detector 56 can be a rotary encoder.

In the sixth example of the first condition, the first condition includes a condition related to the rotational state of the second rotational body 22. The condition related to the rotational state of the second rotational body 22 is satisfied in at least one of a case where a rotational speed of the second rotational body 22 is less than or equal to a second rotational speed and an angular acceleration of the second rotational body 22 is less than or equal to a second angular acceleration. In an example, the second rotational speed and the second angular acceleration are set to values allowing for determination that the crank axle 16 is not rotated by a human driving force. In an example, the second rotational speed and the second angular acceleration are zero or a value approximate to zero.

In the sixth example of the first condition, the electronic controller 92 is configured to determine that the condition related to the rotational state of the second rotational body 22 is satisfied based on a signal received from the fifth detector 58 that detects the rotational state of the second rotational body 22.

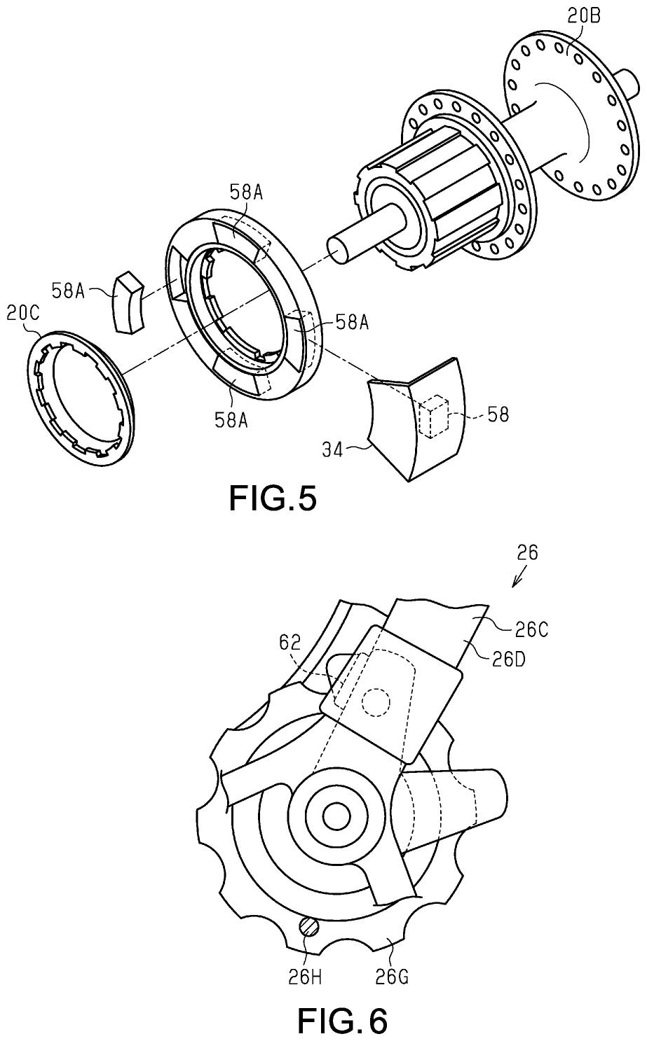

As shown in FIG. 5, for example, the fifth detector 58 is configured to detect the magnetic field of a magnet 58A provided on the second rotational body 22 shown in FIG. 1. In an example, the fifth detector 58 is provided on the frame 34. Two or more magnets 58A can be provided in a circumferential direction of the second rotational body 22. The magnets 58A are attached to the second rotational body 22 by, for example, a lock ring 20C used to mount the second rotational body 22 on a hub 20B of the rear wheel 20R. The fifth detector 58 can be a rotary encoder.

In the seventh example of the first condition, the first condition includes a condition related to the operational state of the linking body 24. The condition related to the operational state of the linking body 24 is satisfied in a case where the moving speed of the linking body 24 is less than or equal to a predetermined moving speed. In an example, the predetermined moving speed is set to a value allowing for determination that the crank axle 16 is not rotated by a human driving force. In an example, the predetermined moving speed is zero or a value approximate to zero.

In the seventh example of the first condition, the electronic controller 92 is configured to determine that the condition related to the operational state of the linking body 24 is satisfied based on a signal received from the sixth detector 60 that detects the operational state of the linking body 24.

In an example, the sixth detector 60 is configured to detect the magnetic field of a magnet provided on the linking body 24. In an example, the sixth detector 60 is provided on the frame 34. The sixth detector 60 can be a linear encoder configured to detect movement of the linking body 24. The sixth detector 60 can be an acceleration sensor provided on the linking body 24.

In the eighth example of the first condition, the first condition includes a condition related to the operational state of the derailleur 26. The condition related to the operational state of the derailleur 26 is satisfied in a case where the rotational speed of the pulley 26G is less than or equal to a predetermined pulley rotational speed. In an example, the predetermined pulley rotational speed is set to a value allowing for determination that the crank axle 16 is not rotated by a human driving force. In an example, the predetermined pulley rotational speed is zero or a value approximate to zero.

In the eighth example of the first condition, the electronic controller 92 is configured to determine that the condition related to the operational state of the derailleur 26 is satisfied based on a signal received from the seventh detector 62 that detects the rotational speed of the pulley 26G.

As shown in FIG. 6, for example, the seventh detector 62 is configured to detect the magnetic field of a magnet 26H provided on the pulley 26G. In an example, the seventh detector 62 is provided on the plate 26F. The seventh detector 62 can be a rotary encoder.

In the ninth example of the first condition, the first condition includes the condition related to the operational state of the derailleur 26. The condition related to the operational state of the derailleur 26 is satisfied in a case where the operational state of the operation portion 26C is a predetermined operational state. In an example, the predetermined operational state is a state allowing for determination that the crank axle 16 is not rotated by a human driving force. In a case where the linking body 24 moves, the operation portion 26C is vibrated in accordance with the movement of the linking body 24. In an example, the predetermined operational state is a state that allows for determination of whether the operation portion 26C is moved in accordance with the movement of the linking body 24.

In the ninth example of the first condition, the electronic controller 92 is configured to determine that the condition related to the operational state of the derailleur 26 is satisfied based on a signal received from the eighth detector 64 that detects the operational state of the operation portion 26C.

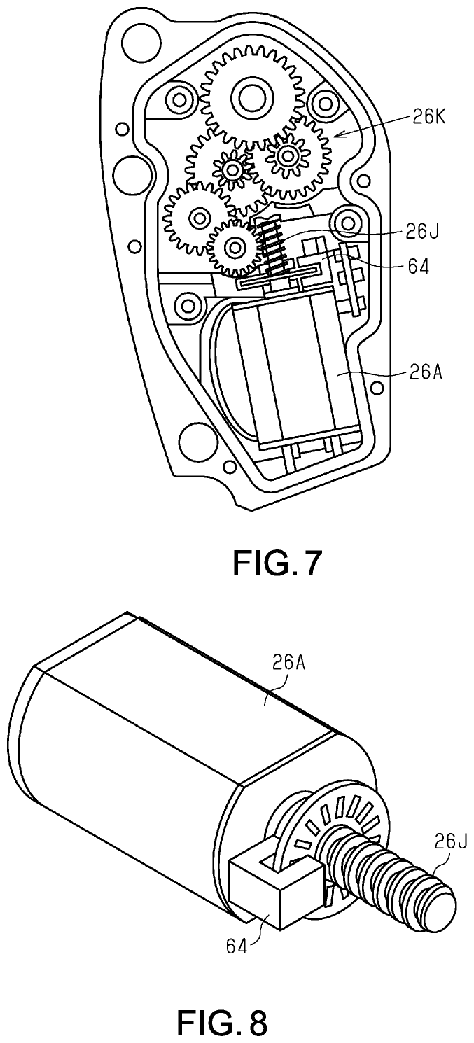

As shown in FIGS. 7 and 8, the eighth detector 64 is provided on the electric actuator 26A. The electric motor of the electric actuator 26A has an output shaft 26J connected to a speed reducer 26K. In an example, the output shaft 26J has a worm, and the worm connects the output shaft 26J and a gear of the speed reducer 26K. In an example, the eighth detector 64 is configured to detect a rotational state of the output shaft 26J. In an example, the eighth detector 64 includes a rotary encoder. The eighth detector 64 can be configured to detect the magnetic field of a magnet provided on the output shaft 26J.

In a case where the linking body 24 moves, the vibration of the operation portion 26C slightly rotates the output shaft 26J. In an example, the electronic controller 92 detects the movement of the linking body 24 in accordance with the rotational state of the output shaft 26J. The eighth detector 64 can be a sensor that detects the distance from the operation portion 26C to the frame 34 or the base 26B. The eighth detector 64 can be a vibration sensor that detects the vibration of the operation portion 26C.

In the tenth example of the first condition, the first condition includes a condition related to the state of at least one of the crank arms 14. The condition related to the state of the at least one of the crank arms 14 includes a condition related to a rotational state of the at least one of the crank arms 14. The condition related to the rotational state of the at least one of the crank arms 14 is satisfied in a case where the rotational state of the at least one of the crank arms 14 is a predetermined rotational state. In an example, the predetermined rotational state is a state allowing for determination that the crank axle 16 is not rotated by a human driving force. In an example, the predetermined rotational state is related to a rotational speed of the at least one of the crank arms 14 and satisfied in a case where the rotational speed of the at least one of the crank arms 14 is less than or equal to a predetermined crank arm rotational speed. The predetermined crank arm rotational speed is zero or a value approximate to zero.

In the tenth example of the first condition, the electronic controller 92 is configured to determine that the condition related to the rotational state of the at least one of the crank arms 14 is satisfied based on a signal received from the ninth detector 66 that detects the rotational state of at least one of the crank arms 14.

In an example, the ninth detector 66 is configured to detect the magnetic field of a magnet provided on at least one of the crank arms 14. In an example, the ninth detector 66 is provided on the frame 34 at a portion that is faceable to the at least one of the crank arms 14. The ninth detector 66 can be provided on the housing 38A of the drive unit 38.

In the eleventh example of the first condition, the first condition includes a condition related the human driving force input to at least one of the crank arms 14. The condition related to the human driving force input to the at least one of the crank arms 14 is satisfied in a case where the human driving force input to the at least one of the crank arms 14 is less than or equal to a predetermined human driving force. In an example, the predetermined human driving force is set to a value allowing for determination that the crank axle 16 is not rotated by a human driving force. In an example, the predetermined human driving force is zero or a value approximate to zero.

In the eleventh example of the first condition, the electronic controller 92 is configured to determine that the condition related to the human driving force input to at least one of the crank arms 14 is satisfied based on a signal received from the tenth detector 68. The tenth detector 68 detects the human driving force input to at least one of the crank arm 14, and is provided on at least one of the crank arms 14 and/or at least one of the pedals 12 of the human-powered vehicle 10.

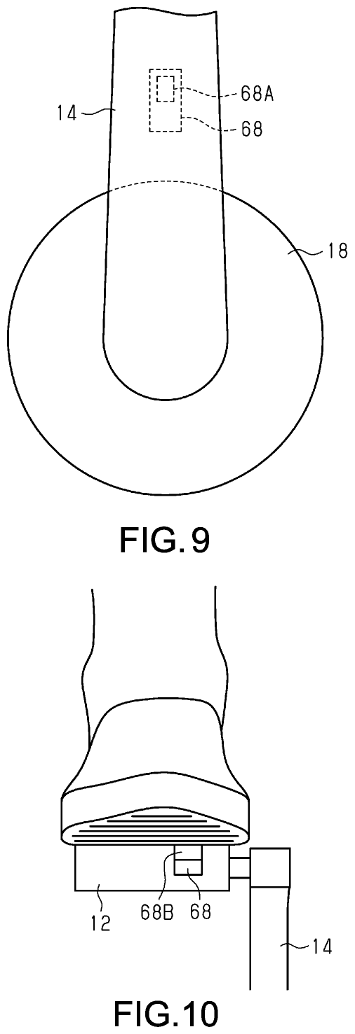

As shown in FIG. 9, the tenth detector 68 includes, for example, a strain sensor 68A provided at an intermediate part of the crank arm 14 in the direction in which the crank arm 14 extends.

As shown in FIG. 10, the tenth detector 68 includes a pressure sensor 68B provided on at least one of the pedals 12.

In the twelfth example of the first condition, the electronic controller 92 is configured to determine that the first condition is satisfied based on a predetermined signal received from the eleventh detector 70. The eleventh detector 70 is configured to output the predetermined signal in a case where a rotational phase of at least one of the crank arms 14 and the crank axle 16 is a predetermined rotational phase. In an example, the predetermined rotational phase is set to a phase allowing for determination that the crank axle 16 is not rotated by a human driving force. In an example, the predetermined rotational phase is a phase at which the crank arm 14 is separated by ninety degrees from the top dead center or the bottom dead center. In an example, the crank arm 14 is maintained at a phase separated by ninety degrees from the top dead center or the bottom dead center in a case where a rider sets his/her foot on one of the pedals 12 without depressing the pedal 12.

In an example in which the rider sets his/her foot on one of the pedals 12, even if the human driving force input to the crank axle 16 is greater than zero, there can be a case where the state of the linking body 24 is unsuitable for operation of the derailleur 26. In the twelfth example of the first condition, a shifting operation can be performed even if the human driving force input to the crank axle 16 is greater than zero in a case where the rider sets his/her foot on one of the pedals 12 without depressing the pedal 12.

In an example, the eleventh detector 70 is configured to detect the rotational phase of at least one of the crank arms 14 and/or the crank axle 16. The eleventh detector 70 can be configured to detect the magnetic field of a magnet that is provided such that the rotational phase of at least one of the crank arms 14 and/or the crank axle 16 corresponds to the predetermined rotational phase. In an example, the eleventh detector 70 is provided on the frame 34 or the housing 38A of the drive unit 38 at a position where the eleventh detector 70 can detect the magnetic field of a magnet provided on at least one of the crank arms 14 and/or the crank axle 16 in a case where the rotational phase of the at least one of the crank arms 14 and/or the crank axle 16 is the predetermined rotational phase.

In the thirteenth example of the first condition, the first condition includes a condition related to the state of at least one of the pedals 12. The condition related to the state of the at least one of the pedals 12 is satisfied in a case where the state of the at least one of the pedals 12 is a predetermined pedal state. In an example, the predetermined pedal state is a state allowing for determination that the crank axle 16 is not rotated by a human driving force.

In the thirteenth example of the first condition, the electronic controller 92 is provided on one of the pedals 12 and configured to determine that the condition related to the state of the at least one of the pedals 12 is satisfied based on a signal received from the twelfth detector 72 that detects the state of the at least one of the pedals 12.

In the fourteenth example of the first condition, the first condition includes a condition related to the state of the tire 20A. The condition related to the state of the tire 20A is satisfied in a case where the state of the tire 20A is a predetermined tire state. In an example, the predetermined tire state is a state allowing for determination that the crank axle 16 is not rotated by a human driving force. In an example, the predetermined tire state is related to changes in the air pressure of the tire 20A and corresponds to a state in which the human-powered vehicle 10 is not being pedaled with a human driving force.

In the fourteenth example of the first condition, the electronic controller 92 is configured to determine that the condition related to the state of the tire 20A is satisfied based on a signal received from the thirteenth detector 74 that detects the state of the tire 20A and is provided on the tire 20A. The thirteenth detector 74 includes, for example, an air pressure sensor.

In the fifteenth example of the first condition, the first condition includes a condition related to the state of the handlebar 30. The condition related to the state of the handlebar 30 is satisfied in a case where the state of the handlebar 30 is a predetermined handlebar state. In an example, the predetermined handlebar state is a state allowing for determination that the crank axle 16 is not rotated by a human driving force. In an example, the predetermined handlebar state is related to a load applied to the handlebar 30 and corresponds to a state in which the human-powered vehicle 10 is not being pedaled with a human driving force.

In the fifteenth example of the first condition, the electronic controller 92 is configured to determine that the condition related to the state of the handlebar 30 is satisfied based on a signal received from the fourteenth detector 76 that detects the state of the handlebar 30 and is provided on the handlebar 30.

In the sixteenth example of the first condition, the first condition includes a condition related to the state of the saddle 32. The condition related to the state of the saddle 32 is satisfied in a case where the state of the saddle 32 is a predetermined saddle state. In an example, the predetermined saddle state is a state allowing for determination that the crank axle 16 is not rotated by a human driving force.

In the sixteenth example of the first condition, the electronic controller 92 is configured to determine that the condition related to the state of the saddle 32 is satisfied based on a signal received from the sixteenth detector 80 that detects the state of the saddle 32 and is provided on the saddle 32.

In the seventeenth example of the first condition, the first condition includes a condition related to the positional information of the human-powered vehicle 10. The condition related to the positional information of the human-powered vehicle 10 is satisfied in a case where a traveling distance of the human-powered vehicle 10 per predetermined time is less than or equal to a predetermined distance. In an example, the predetermined distance is set to a value allowing for determination that the crank axle 16 is not rotated by a human driving force. In an example, the predetermined distance is zero or a value approximate to zero.

In the seventeenth example of the first condition, the electronic controller 92 is configured to determine that the condition related to the positional information of the human-powered vehicle 10 is satisfied based on a signal received from the sixteenth detector 80 that detects the positional information of the human-powered vehicle 10. The sixteenth detector 80 includes, for example, a global positioning system (GPS) receiver.

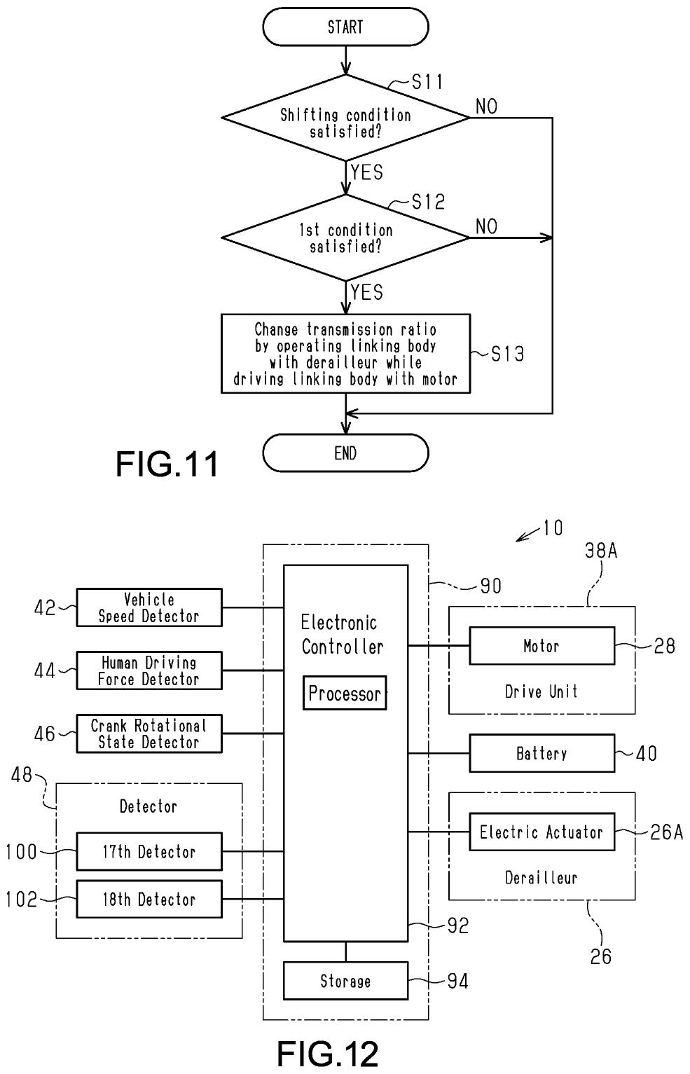

A process executed by the electronic controller 92 to control the motor 28 and the derailleur 26 will now be described with reference to FIG. 11. In an example in which electric power is supplied to the electronic controller 92, the electronic controller 92 starts the process of the flowchart shown in FIG. 11 from step S11. In a case where the process of the flowchart shown in FIG. 11 ends, the electronic controller 92 repeats the process from step S11 in predetermined cycles until, for example, the supply of electric power is stopped.

In step S11, the electronic controller 92 determines whether the shifting condition is satisfied. In a case where the shifting condition has been satisfied, the electronic controller 92 proceeds to step S12. In a case where the shifting condition is not satisfied, the electronic controller 92 ends processing.

In step S12, the electronic controller 92 determines whether the first condition is satisfied. In a case where the first condition has been satisfied, the electronic controller 92 proceeds to step S13. In a case where the first condition is not satisfied, the electronic controller 92 ends processing.

In step S13, the electronic controller 92 changes the transmission ratio R by operating the linking body 24 with the derailleur 26 while driving the linking body 24 with the motor 28. Then, the electronic controller 92 ends processing.

### Second Embodiment

A control device 90 in accordance with a second embodiment will now be described with reference to FIGS. 1 and 12. The control device 90 in accordance with the second embodiment is the same as the control device 90 of the first embodiment except in that the first condition differs from that of the first embodiment. Thus, same reference numerals are given to those components of the control device 90 in the second embodiment that are the same as the corresponding components of the first embodiment. Such components will not be described in detail.

The human-powered vehicle 10 of the present embodiment further includes at least one of a suspension 84 and an adjustable seatpost 86. The first condition of the present embodiment includes a condition related to at least one of a state of the suspension 84 and a state of the adjustable seatpost 86.

The suspension 84 includes at least one of a rear suspension device and a front suspension device. The suspension 84 absorbs impacts applied to the wheel 20. The suspension 84 can be a hydraulic suspension or an air suspension. The suspension 84 includes a first portion and a second portion. The second portion is fitted to the first portion and is movable relative to the first portion. An actuation state of the suspension 84 includes, for example, a locked state in which relative movement of the first portion and the second portion is restricted and an unlocked state in which relative movement of the first portion and the second portion is permitted. The actuation state of the suspension 84 is switched by an electric actuator. The locked state of the suspension 84 can include a state in which the first portion and the second portion move relative to each other in a case where a strong force is applied to the wheel 20. Instead of or in addition to the locked state and the unlocked state, the actuation state of the suspension 84 can include at least one of a plurality of actuation states that differ in damping force and a plurality of actuation states that differ in a stroke amount.

The rear suspension device is configured to be provided on the frame 34 of the human-powered vehicle 10. The rear suspension device is provided between a frame body of the frame 34 and a swingarm that supports the rear wheel 20R. The rear suspension device absorbs impacts applied to the rear wheel 20R. The front suspension device is configured to be provided between the frame 34 and the front wheel 20F of the human-powered vehicle 10. The front suspension device is provided on the front fork 36. The front suspension device absorbs impacts applied to the front wheel 20F.

The suspension 84 can include an electric actuator for actuating the suspension 84. The electric actuator includes an electric motor. The electric motor included in the electric actuator can be replaced by a solenoid. The electric actuator is driven by a drive circuit in response to a control signal from the control device 90.

The adjustable seatpost 86 is provided on a seat tube and configured to change the height of the saddle 32. The adjustable seatpost 86 includes an electric seatpost or a mechanical seatpost. An electric seatpost is extended and retracted by the force of an electric actuator. A mechanical seatpost is extended by at least spring force or pneumatic force with a valve controlled by the force of an electric actuator, and the mechanical seatpost is retracted by adding human force. The mechanical seatpost includes a hydraulic seatpost and a hydraulic/pneumatic seatpost.

Table 2 illustrates the relationship of a detector type used in each example of the first condition in accordance with the second embodiment and a specific example in which the first condition is satisfied. The specific example in which the first condition is satisfied is used for determining that the state of the linking body 24 is unsuitable for a shifting operation with the derailleur 26. In an example, the electronic controller 92 is configured to change the transmission ratio R by operating the linking body 24 with the derailleur 26 while driving the linking body 24 with the motor 28 in a case where a first condition that corresponds to an eighteenth example or a nineteenth example is satisfied. In an example, the electronic controller 92 can be configured to change the transmission ratio R by operating the linking body 24 with the derailleur 26 while driving the linking body 24 with the motor 28 in a case where first conditions that respectively correspond to the eighteenth and nineteenth examples are both satisfied. The electronic controller 92 can be configured to change the transmission ratio R by operating the linking body 24 with the derailleur 26 while driving the linking body 24 with the motor 28 in a case where first conditions that correspond to a predetermined one or more of the first to seventeenth examples and a first condition that corresponds to at least one of the eighteenth and nineteenth examples, which is determined in advance, are all satisfied. The electronic controller 92 can be configured to change the transmission ratio R by operating the linking body 24 with the derailleur 26 while driving the linking body 24 with the motor 28 in a case where first conditions that correspond to predetermined two or more of the first to nineteenth examples are all satisfied.

TABLE 2

| | Detector | Specific Example of 1st Condition |
|---|---|---|
| 18th Example | 17th Detector | State of Suspension = Predetermined |
| | | Suspension State |
| 19th Example | 18th Detector | State of Adjustable Seatpost = |
| | | Predetermined Seatpost State |

In an example in which the human-powered vehicle 10 includes the suspension 84, the first condition includes the eighteenth example. In the eighteenth example of the first condition, the first condition is satisfied in a case where the state of the suspension 84 is a predetermined suspension state. In an example, the predetermined suspension state is a state allowing for determination that the crank axle 16 is not rotated by a human driving force. In an example, the predetermined suspension state corresponds to a state in which an impact applied to the suspension 84 is small. In an example, the electronic controller 92 determines that the first condition is satisfied in a case where a change amount in the stroke length of the suspension 84 per unit time is less than or equal to a predetermined change amount.

In the eighteenth example of the first condition, the electronic controller 92 is configured to determine that the condition related to the state of the suspension 84 is satisfied based on a signal received from a seventeenth detector 100 that detects the state of the suspension 84.

In an example in which the human-powered vehicle 10 includes the adjustable seatpost 86, the first condition includes the nineteenth example. In the nineteenth example of the first condition, the first condition is satisfied in a case where the state of the adjustable seatpost 86 is a predetermined seatpost state. In an example, the predetermined seatpost state is a state allowing for determination that the crank axle 16 is not rotated by a human driving force. In an example, the predetermined seatpost state corresponds to a state in which an impact applied to the adjustable seatpost 86 is small. In an example, the electronic controller 92 determines that the first condition is satisfied in a case where a load changed amount of the adjustable seatpost 86 is less than or equal to a predetermined load changed amount.

In the nineteenth example of the first condition, the electronic controller 92 is configured to determine that the condition related to the state of the adjustable seatpost 86 is satisfied based on a signal received from an eighteenth detector 102 that detects the state of the adjustable seatpost 86.

Instead of or in addition to at least one of the eighteenth and nineteenth examples, the electronic controller 92 of the present embodiment can be configured to change the transmission ratio R by operating the linking body 24 with the derailleur 26 while driving the linking body 24 with the motor 28 in accordance with at least one of the first to seventeenth examples of the first condition in the first embodiment.

### Third Embodiment

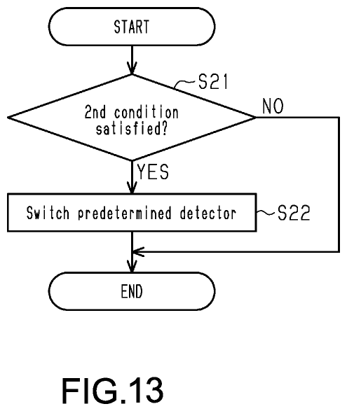

A control device 90 in accordance with a third embodiment will now be described with reference to FIGS. 1, 2, 3, 12, and 13. The control device 90 in accordance with the third embodiment is the same as the control device 90 of the first and second embodiments except in that the process of the flowchart shown in FIG. 13 is performed. Thus, same reference numerals are given to those components of the control device 90 in the third embodiment that are the same as the corresponding components of the first and second embodiments. Such components will not be described in detail.

The electronic controller 92 of the present embodiment is configured to change the transmission ratio R by operating the linking body 24 with the derailleur 26 while driving the linking body 24 with the motor 28 in a case where the first condition related to pedaling is satisfied. The electronic controller 92 is configured to determine that the first condition is satisfied based on a signal received from a predetermined detector that is at least one of a plurality of detectors 48. The electronic controller 92 is configured to switch the predetermined detector in accordance with a second condition.

In an example, the electronic controller 92 is configured to determine whether the first condition is satisfied using a predetermined condition that is at least one of a plurality of first conditions. In an example, the electronic controller 92 is configured to determine that the first condition is satisfied in a case where the predetermined condition is satisfied. In an example, the electronic controller 92 is configured to determine that the first condition is satisfied based on a signal received from the at least one predetermined detector, which is the detector 48 that corresponds to the predetermined condition.

In an example, the second condition includes a condition related to an anomaly in the plurality of detectors 48. In an example in which a signal received from the predetermined detector includes an anomalous signal, the electronic controller 92 sets a different detector 48 of the plurality of detectors 48 as the predetermined detector. In an example in which the electronic controller 92 switches the predetermined detector, the electronic controller 92 sets the predetermined condition to a first condition that corresponds to the set predetermined detector. An anomalous signal is a signal related to wire breakage, short-circuiting, and the like in the detector 48. The second condition can include a condition related to a traveling state and a traveling environment of the human-powered vehicle 10. The second condition can include a condition related to types of the detectors 48 included in the human-powered vehicle 10.

The electronic controller 92 of the present embodiment can set the predetermined condition to at least one of the first to nineteenth examples of the first condition in the first and second embodiments. In addition to the at least one of the first to nineteenth examples of the first condition in the first and second embodiments, the electronic controller 92 of the present embodiment can set the predetermined condition to at least one of a twentieth example, twenty-first example, twenty-second example, twenty-third example, and twenty-fourth example.

In the twentieth example of the first condition, the first condition includes a condition related to the rotational speed of the crank axle 16. In an example, the condition related to the rotational speed of the crank axle 16 is satisfied in a case where the rotational speed of the crank axle 16 is less than or equal to a predetermined crank rotational speed. In the twentieth example of the first condition, the electronic controller 92 determines whether the condition related to the rotational speed of the crank axle 16 is satisfied in accordance with, for example, an output of the crank rotational state detector 46.

In the twenty-first example of the first condition, the first condition includes a condition related to the speed of the human-powered vehicle 10. In an example, the condition related to the speed of the human-powered vehicle 10 is satisfied in a case where the vehicle speed is less than or equal to a predetermined vehicle speed. In the twenty-first example of the first condition, the electronic controller 92 determines whether the condition related to the vehicle speed of the human-powered vehicle 10 is satisfied in accordance with, for example, an output of the vehicle speed detector 42.

In the twenty-second example of the first condition, the first condition includes a condition related to the human driving force input to the crank axle 16. In an example, the condition related to the human driving force input to the crank axle 16 is satisfied in a case where the human driving force is less than or equal to a predetermined human driving force. In the twenty-second example of the first condition, the electronic controller 92 determines whether the condition related to the human driving force input to the crank axle 16 is satisfied in accordance with, for example, an output of the torque sensor 44A.

In the twenty-third example of the first condition, the first condition includes a condition related to image capturing information. In an example, the condition related to the image capturing information is satisfied in a case where at least one of a state of the human-powered vehicle 10 and a state of a rider captured by an image capturing device is a predetermined image capturing state. The predetermined image capturing state includes, for example, at least one of a state in which the human-powered vehicle 10 is still and a state in which the rider is not pedaling. In the twenty-third example of the first condition, the electronic controller 92 determines whether the condition related to the image capturing information is satisfied in accordance with, for example, an output of the image capturing device that captures the human-powered vehicle 10, the rider, and the road on which the human-powered vehicle 10 is traveling.

In the twenty-fourth example of the first condition, the first condition includes a condition related to a distance to a subject. In an example, the condition related to a distance to a subject is satisfied in a case where the distance detected by an infrared light detector to a subject is a predetermined distance state. In an example, the infrared light detector is provided on one of the frame 34 and the pedals 12, and the subject is provided on the other one of the frame 34 and the pedals 12. In the twenty-fourth example of the first condition, the electronic controller 92 determines whether the condition related to the distance to the subject is satisfied in accordance with, for example, an output of the infrared light detector.

Table 3 illustrates examples of the predetermined detectors.

TABLE 3

| | Detection Subject of | |
|---|---|---|
| | Predetermined Detector | Predetermined Detector |
| X1 | Rotational Speed of Crank Axle | Crank Rotational State Detector |
| X2 | Rotational Angle of Crank Axle | 11th Detector or 9th Detector |
| X3 | Angular Acceleration of Crank | 1st Detector |
| | Axle | |
| X4 | Human Driving Force Input to | 10th Detector |
| | Crank Arm | |
| X5 | Human Driving Force Input to | Torque Sensor |
| | Crank Axle | |
| X6 | Rotational Speed of Motor | 2nd Detector |
| X7 | Current Value of Motor | 3rd Detector |
| X8 | Rotational State of 2nd | 5th Detector |
| | Rotational Body | |
| X9 | Rotational State of Pulley | 7th Detector |
| X10 | Vehicle Speed | Vehicle Speed Detector |
| X11 | State of Pedal | 12th Detector |
| X12 | State of Saddle | 15th Detector |
| X13 | State of Suspension | 17th Detector |
| X14 | State of Adjustable Seatpost | 18th Detector |
| X15 | State of Handlebar | 14th Detector |
| X16 | State of Tire | 13th Detector |
| X17 | Image Capturing Information | Image Capturing Device |
| X18 | Distance to Subject | Infrared Light Detector |
| X19 | Positional Information | 16th Detector |

Table 4 illustrates examples of the predetermined detectors that are suitably replaceable with each predetermined detector. The classifications X1 to X19 in Table 4 correspond to X1 to X19 in Table 3. The circle “∘” in Table 4 indicates a predetermined detector that is suitably replaceable with each predetermined detector. In an example in which the predetermined detector is X2, the electronic controller 92 switches the predetermined detector with at least one of X7, X10, X11, and X19 in a case where the second condition is satisfied. In a case where multiple examples of the first condition correspond to a single predetermined detector, the electronic controller 92 can be configured to select one of the examples of the first condition that correspond to the single predetermined detector.

TABLE 4

| | | | | | | | | | | | | | | | | | | |
|---|---|---|---|---|---|---|---|---|---|---|---|---|---|---|---|---|---|---|
| X1 | X2 | X3 | X4 | X5 | X6 | X7 | X8 | X9 | X10 | X11 | X12 | X13 | X14 | X15 | X16 | X17 | X18 | X19 |

| | | | | | | | | | | | | | | | | | | |
|---|---|---|---|---|---|---|---|---|---|---|---|---|---|---|---|---|---|---|
| X1 | | | | | | | | | | | | | | | | | | |
| X2 | ◯ | | | | | | | | | | | | | | | | | |
| X3 | ◯ | | | | | | | | | | | | | | | | | |
| X4 | ◯ | | ◯ | | | | | | | | | | | | | | | |
| X5 | ◯ | | ◯ | | | | | | | | | | | | | | | |
| X6 | ◯ | | ◯ | | | | | | | | | | | | | | | |
| X7 | ◯ | ◯ | ◯ | ◯ | ◯ | ◯ | | | | | | | | | | | | |
| X8 | ◯ | | ◯ | | | | ◯ | | | | | | | | | | | |
| X9 | ◯ | | ◯ | | | | ◯ | | | | | | | | | | | |
| X10 | ◯ | ◯ | ◯ | ◯ | ◯ | ◯ | ◯ | ◯ | ◯ | | | | | | | | | |
| X11 | ◯ | ◯ | ◯ | ◯ | ◯ | ◯ | ◯ | ◯ | ◯ | ◯ | | | | | | | | |
| X12 | ◯ | | ◯ | | | | ◯ | | ◯ | | ◯ | | | | | | | |
| X13 | ◯ | | ◯ | | | | ◯ | | ◯ | | ◯ | | | | | | | |
| X14 | ◯ | | ◯ | | | | ◯ | | ◯ | | ◯ | | | | | | | |
| X15 | ◯ | | ◯ | | | | ◯ | | ◯ | | ◯ | | | | | | | |
| X16 | ◯ | | ◯ | | | | ◯ | | ◯ | | ◯ | | | | | | | |
| X17 | ◯ | | ◯ | | | | ◯ | ◯ | ◯ | | ◯ | | ◯ | | | | | |
| X18 | ◯ | | ◯ | | | | ◯ | | ◯ | | ◯ | | | | | | | |
| X19 | ◯ | ◯ | ◯ | ◯ | ◯ | ◯ | ◯ | ◯ | ◯ | ◯ | ◯ | ◯ | ◯ | ◯ | ◯ | ◯ | ◯ | ◯ |

A process executed by the electronic controller 92 to switch the predetermined detector will now be described with reference to FIG. 13. In an example in which electric power is supplied to the electronic controller 92, the electronic controller 92 starts the process of the flowchart shown in FIG. 13 from step S21. In a case where the process of the flowchart shown in FIG. 13 ends, the electronic controller 92 repeats the process from step S21 in predetermined cycles until, for example, the supply of electric power is stopped.

In step S21, the electronic controller 92 determines whether the second condition is satisfied. In a case where the second condition has been satisfied, the electronic controller 92 proceeds to step S22. In a case where the second condition is not satisfied, the electronic controller 92 ends processing.

In step S22, the electronic controller 92 switches the predetermined detector and then ends processing.

### Modifications

The description related with the above embodiments exemplifies, without any intention to limit, applicable forms of a human-powered vehicle control device according to the present disclosure. In addition to the embodiments described above, the human-powered vehicle control device according to the present disclosure is applicable to, for example, modifications of the above embodiments that are described below and combinations of at least two of the modifications that do not contradict each other. In the modifications described hereafter, same reference numerals are given to those components that are the same as the corresponding components of the above embodiments. Such components will not be described in detail.

Instead of or in addition to at least one of the first to twentieth examples of the first condition in the first and second embodiments, the first condition can include a condition related to a driving force transmission state between two adjacent ones of drive train elements. The human-powered vehicle 10 includes the drive train elements. The drive train elements include the crank axle 16, the first rotational body 18 connected to the crank axle 16, the wheel 20, the second rotational body 22 connected to the wheel 20, and the linking body 24 engaged with the first rotational body 18 and the second rotational body 22 and configured to transmit driving force between the first rotational body 18 and the second rotational body 22. In an example, the electronic controller 92 determines that the first condition is satisfied in a case where the driving force transmission state between two adjacent ones of the drive train elements is a non-transmission state. In an example, the electronic controller 92 is configured to determine whether the first condition is satisfied in accordance with the connection state of a clutch included in the drive train elements. The clutch can include, for example, the first one-way clutch 38B.

The phrase “at least one of” as used in this disclosure means “one or more” of a desired choice. For one example, the phrase “at least one of” as used in this disclosure means “only one single choice” or “both of two choices” if the number of its choices is two. For another example, the phrase “at least one of” as used in this disclosure means “only one single choice” or “any combination of equal to or more than two choices” if the number of its choices is equal to or more than three.

What is claimed is:

1. A control device for a human-powered vehicle, wherein the human-powered vehicle includes a pair of pedals, a pair of crank arms connected to the pedals, a crank axle connected to the crank arms, a first rotational body connected to the crank axle, a wheel including a tire, a second rotational body connected to the wheel, a linking body engaged with the first rotational body and the second rotational body and configured to transmit driving force between the first rotational body and the second rotational body, a derailleur configured to operate the linking body to change a transmission ratio of a rotational speed of the wheel to a rotational speed of the crank axle, a motor configured to drive the linking body, a handlebar, and a saddle, the control device comprising:
an electronic controller configured to output a signal to control the motor,
the electronic controller being further configured to output a signal to change the transmission ratio by operating the linking body with the derailleur while driving the linking body with the motor in a case where a first condition related to pedaling is satisfied; and
the first condition includes a condition related to at least one of a state of at least one of the pedals, a human driving force input to at least one of the pedals, a state of at least one of the crank arms, a human driving force input to at least one of the crank arms, an angular acceleration of the crank axle, a rotational state of the first rotational body, a state of the tire, a rotational state of the second rotational body, an operational state of the linking body, an operational state of the derailleur, a rotational state of the motor, an electric energy supplied to the motor, a state of the handlebar, a state of the saddle, and positional information of the human-powered vehicle.

2. The control device according to claim 1, wherein
the first condition includes a condition related to the angular acceleration of the crank axle, and is satisfied in a case where the angular acceleration of the crank axle is less than or equal to a predetermined angular acceleration.

3. The control device according to claim 2, wherein
the electronic controller is configured to determine that the condition related to the angular acceleration of the crank axle is satisfied based on a signal received from a first detector that detects the angular acceleration of the crank axle.

4. The control device according to claim 1, wherein
the first condition includes a condition related to the rotational state of the motor; and
the condition related to the rotational state of the motor includes a condition related to a rotational speed of the motor, and is satisfied in a case where the rotational speed of the motor is less than or equal to a predetermined motor rotational speed.

5. The control device according to claim 1, wherein
the first condition includes a condition related to the rotational state of the motor; and
the condition related to the rotational state of the motor includes a condition related to a rotational amount of the motor, and is satisfied in a case where the rotational amount of the motor is less than or equal to a predetermined motor rotational amount.

6. The control device according to claim 4, wherein
the electronic controller is configured to determine that the condition related to the rotational state of the motor is satisfied based on a signal received from a second detector that detects the rotational state of the motor.

7. The control device according to claim 1, wherein
the first condition includes a condition related to the electric energy supplied to the motor and is satisfied in a case where a current value of the electric energy is less than or equal to a predetermined current value.

8. The control device according to claim 7, wherein
the electronic controller is configured to determine that the condition related to the electric energy supplied to the motor is satisfied based on a signal received from a third detector that detects the electric energy supplied to the motor.

9. The control device according to claim 1, wherein
the first condition includes a condition related to the rotational state of the first rotational body; and
the condition related to the rotational state of the first rotational body is satisfied in at least one of a case where a rotational speed of the first rotational body is less than or equal to a first rotational speed and an angular acceleration of the first rotational body is less than or equal to a first angular acceleration.

10. The control device according to claim 9, wherein
the electronic controller is configured to determine that the condition related to the rotational state of the first rotational body is satisfied based on a signal received from a fourth detector that detects the rotational state of the first rotational body.

11. The control device according to claim 1, wherein
the first condition includes a condition related to the rotational state of the second rotational body; and
the condition related to the rotational state of the second rotational body is satisfied in at least one of a case where a rotational speed of the second rotational body is less than or equal to a second rotational speed and an angular acceleration of the second rotational body is less than or equal to a second angular acceleration.

12. The control device according to claim 11, wherein
the electronic controller is configured to determine that the condition related to the rotational state of the second rotational body is satisfied based on a signal received from a fifth detector that detects the rotational state of the second rotational body.

13. The control device according to claim 1, wherein
the first condition includes a condition related to the operational state of the linking body; and
the condition related to the operational state of the linking body is satisfied in a case where a moving speed of the linking body is less than or equal to a predetermined moving speed.

14. The control device according to claim 13, wherein
the electronic controller is configured to determine that the condition related to the operational state of the linking body is satisfied based on a signal received from a sixth detector that detects the operational state of the linking body.

15. The control device according to claim 1, wherein
the first condition includes a condition related to the operational state of the derailleur;
the derailleur includes a pulley around which the linking body is wound; and
the condition related to the operational state of the derailleur is satisfied in a case where a rotational speed of the pulley is less than or equal to a predetermined pulley rotational speed.

16. The control device according to claim 15, wherein
the electronic controller is configured to determine that the condition related to the operational state of the derailleur is satisfied based on a signal received from a seventh detector that detects the rotational speed of the pulley.

17. The control device according to claim 1, wherein
the first condition includes a condition related to the operational state of the derailleur;
the derailleur includes a base provided on a frame of the human-powered vehicle and an operation portion that is attached to the base and movable relative to the base; and
the condition related to the operational state of the derailleur is satisfied in a case where an operational state of the operation portion is a predetermined operational state.

18. The control device according to claim 17, wherein
the electronic controller is configured to determine that the condition related to the operational state of the derailleur is satisfied based on a signal received from an eighth detector that detects the operational state of the operation portion.

19. The control device according to claim 1, wherein
the first condition includes a condition related to the state of the at least one of the crank arms;
the condition related to the state of the at least one of the crank arms includes a condition related to a rotational state of the at least one of the crank arms; and
the condition related to the rotational state of the at least one of the crank arms is satisfied in a case where the rotational state of the at least one of the crank arms is a predetermined rotational state.

20. The control device according to claim 19, wherein
the electronic controller is configured to determine that the condition related to the rotational state of the at least one of the crank arms is satisfied based on a signal received from a ninth detector that detects the rotational state of the at least one of the crank arms.

21. The control device according to claim 1, wherein
the first condition includes a condition related to the human driving force input to the at least one of the crank arms; and
the condition related to the human driving force input to the at least one of the crank arms is satisfied in a case where the human driving force input to the at least one of the crank arms is less than or equal to a predetermined human driving force.

22. The control device according to claim 21, wherein
the electronic controller is configured to determine that the condition related to the human driving force input to the at least one of the crank arms is satisfied based on a signal received from a tenth detector that detects the human driving force input to the at least one of the crank arms and is provided on at least one of the at least one of the crank arms and the at least one of the pedals of the human-powered vehicle.

23. The control device according to claim 1, wherein
the electronic controller is configured to determine that the first condition is satisfied based on a predetermined signal received from an eleventh detector; and
the eleventh detector is configured to output the predetermined signal in a case where a rotational phase of at least one of the at least one of the crank arms and the crank axle is a predetermined rotational phase.

24. A control device for a human-powered vehicle, wherein the human-powered vehicle includes a pair of crank arm that receives a human driving force, a crank axle connected to the crank arms, a first rotational body connected to the crank axle, a wheel, a second rotational body connected to the wheel, a linking body engaged with the first rotational body and the second rotational body and configured to transmit driving force between the first rotational body and the second rotational body, a derailleur configured to operate the linking body to change a transmission ratio of a rotational speed of the wheel to a rotational speed of the crank axle, and a motor configured to drive the linking body, the control device comprising:
an electronic controller configured to output a signal to control the motor,
the electronic controller being further configured to output a signal to change the transmission ratio by operating the linking body with the derailleur while driving the linking body with the motor in a case where a first condition related to pedaling is satisfied;
the electronic controller being further configured to determine that the first condition is satisfied based on a signal received from a predetermined detector that is at least one of a plurality of detectors; and
the electronic controller being further configured to switch the predetermined detector in accordance with a second condition.

25. The control device according to claim 24, wherein
the second condition includes a condition related to an anomaly in the plurality of detectors.

26. A control device for a human-powered vehicle, wherein the human-powered vehicle includes a crank axle, a first rotational body connected to the crank axle, a wheel, a second rotational body connected to the wheel, a linking body engaged with the first rotational body and the second rotational body and configured to transmit driving force between the first rotational body and the second rotational body, a derailleur configured to operate the linking body to change a transmission ratio of a rotational speed of the wheel to a rotational speed of the crank axle, and a motor configured to drive the linking body, and the human-powered vehicle further includes at least one of a suspension and an adjustable seatpost, the control device comprising:
an electronic controller configured to output a signal to control the motor,
the electronic controller being further configured to output a signal to change the transmission ratio by operating the linking body with the derailleur while driving the linking body with the motor in a case where a first condition related to pedaling is satisfied; and
the first condition includes a condition related to at least one of a state of the suspension and a state of the adjustable seatpost.

27. A control device for a human-powered vehicle, wherein the human-powered vehicle includes drive train elements including a crank axle, a first rotational body connected to the crank axle, a wheel, a second rotational body connected to the wheel, and a linking body engaged with the first rotational body and the second rotational body and configured to transmit driving force between the first rotational body and the second rotational body, and the human-powered vehicle further includes a derailleur configured to operate the linking body to change a transmission ratio of a rotational speed of the wheel to a rotational speed of the crank axle, and a motor configured to drive the linking body, the control device comprising:
an electronic controller configured to output a signal to control the motor,
the electronic controller being further configured to output a signal to change the transmission ratio by operating the linking body with the derailleur while driving the linking body with the motor in a case where a first condition related to pedaling is satisfied; and
the first condition includes a condition related to a driving force transmission state between two adjacent ones of the drive train elements.
